(19) United States
(12) Patent Application Publication
(10) Pub. No.: US 2014/0215042 A1
(43) Pub. Date: Jul. 31, 2014

(54) ELECTRONIC APPARATUS, SYSTEM, AND MANAGEMENT METHOD

(71) Applicant: Kabushiki Kaisha Toshiba, Tokyo (JP)

(72) Inventor: Hidetoshi Yokoi, Ome-shi (JP)

(73) Assignee: Kabushiki Kaisha Toshiba, Tokyo (JP)

(21) Appl. No.: 14/014,161

(22) Filed: Aug. 29, 2013

Related U.S. Application Data
(63) Continuation of application No. PCT/JP2013/058800, filed on Mar. 26, 2013.

(30) Foreign Application Priority Data
Jan. 31, 2013 (JP) 2013-017768

(51) Int. Cl. H04L 12/24

(52) U.S. Cl. CPC H04L 41/0213
USPC 709/223

(57) ABSTRACT

According to one embodiment, an electronic apparatus includes a communication module and a manager. The communication module performs communication with a plurality of terminals and receives, from the terminals, position information indicating positions of respective terminals and identification information of the respective terminals. The manager manages, based on the position information of the respective terminals, one or more identification information transmitted from one or more terminals located in the same area.

### CROSS REFERENCE TO RELATED APPLICATIONS

This application is a Continuation Application of PCT Application No. PCT/JP2013/058800, filed Mar. 26, 2013 and based upon and claiming the benefit of priority from Japanese Patent Application No. 2013-017768, filed Jan. 31, 2013, the entire contents of all of which are incorporated herein by reference.

### FIELD

Embodiments described herein relate generally to a technique for managing a terminal based on position information thereof.

### BACKGROUND

In recent years, terminals, such as mobile phones, smartphones, and tablet computers each of which is provided with a device, such as a GPS, that measures a current position become widespread.

There is a demand that a terminal is managed using position information measured by the terminal.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram illustrating an example of a configuration of a system according to an embodiment.

FIG. 2 is an exemplary block diagram illustrating a system configuration of an electronic apparatus of the embodiment.

FIG. 3 is an exemplary block diagram illustrating a system configuration of a terminal according to the embodiment.

FIG. 4 is an exemplary view illustrating a procedure for sharing a photo.

### DETAILED DESCRIPTION

Various embodiments will be described hereinafter with reference to the accompanying drawings.

In general, according to one embodiment, an electronic apparatus includes a communication module and a manager. The communication module is configured to perform communication with a plurality of terminals and to receive, from the terminals, position information indicating positions of respective terminals and identification information of the respective terminals. The manager is configured to manage, based on the position information of the respective terminals, one or more identification information transmitted from one or more terminals located in the same area.

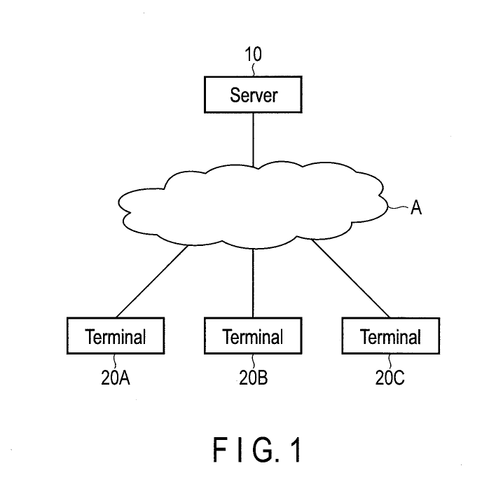

FIG. 1 is a block diagram illustrating an example of a configuration of a system including an electronic apparatus and terminals.

The electronic apparatus can be realized by, e.g., a server computer. The terminals can be realized by a tablet computer, a note-type personal computer, a smartphone, a PDA, or the like.

As illustrated in FIG. 1, a system includes a plurality of terminals 20A, 20B, 20C, and the like. A server 10 and terminals 20A, 20B, and 20C are connected to a network A.

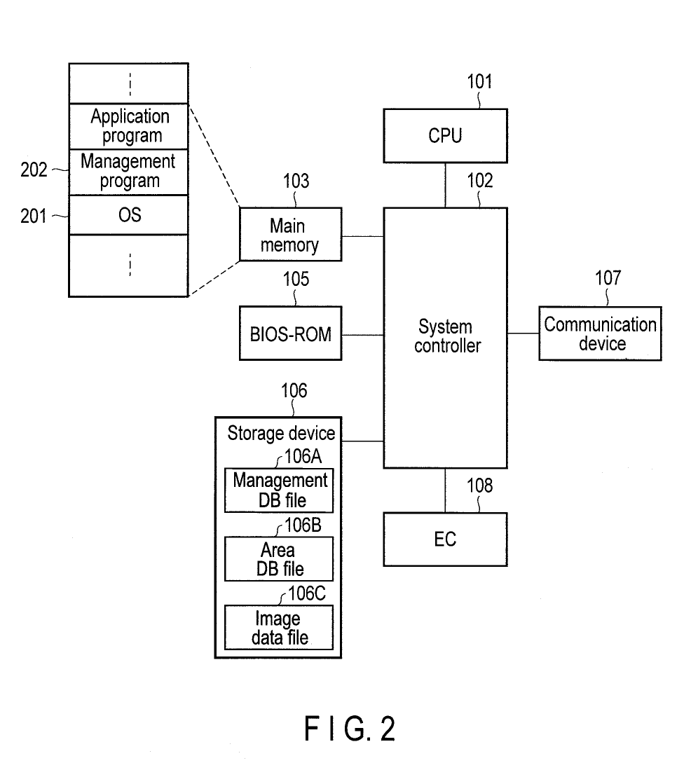

FIG. 2 is a view illustrating a system configuration of a server.

As illustrated in FIG. 2, the server 10 includes a CPU 101, a system controller 102, a main memory 103, a BIOS-ROM 105, a storage device 106, a communication device 107, an embedded controller (EC) 108, and the like.

The CPU 101 is a processor that controls operations of various modules in the server 10. The CPU 101 executes various programs loaded from the storage device 106 into the main memory 103. The program executed by the CPU 101 includes various application programs such as an operating system (OS) 201 and a management program 202.

The CPU 101 executes the management program 202 to thereby realize various functions such as a function of managing identification information transmitted from a terminal (to be described later) located in the same area and a function of managing data transmitted from a terminal (to be described later) located in the same area. As the identification data, a user ID, an IP address assigned to a terminal, a product number of a terminal can be used.

Moreover, the CPU 101 executes a BIOS (Basic Input/Output System) stored in the BIOS-ROM 105. The BIOS is a program for hardware control.

The system controller 102 is a device that connects a local bus of the CPU 101 and various components. The system controller 102 incorporates therein a memory controller for access control of the main memory 103.

The communication device 107 is a device configured to execute communication with a device connected to the Internet.

The EC 108 is a one-chip microcomputer that includes an embedded controller for power management. The EC 108 has a function of powering on or off the server 10 in response to user's power button operation.

The storage device 106 stores therein a management database file 106A, an area database file 106B, and an image file 106C transmitted from the terminal 20 (20A, 20B, 20C). The management database file 106A registers therein user information associating a user ID as the identification information, a password, and a user name. When position information indicating a position of a terminal and a user ID are received transmitted from the terminal, area information indicating an area corresponding to the terminal location is newly associated with information in the user information in which the received user is registered. When an image data file and a user ID are received from a terminal, address information indicating a storage location of the image data file is newly associated with information in the user information in which the received user is registered.

The area database file 106B associates area information indicating an area, such as a municipality, facilities such as a park and an amusement park with range information indicating a range of the area.

Upon reception of the user ID and password transmitted from the terminal 20A, the management program 202 performs user authentication based on the received user ID/password and user ID/password registered in the management database file 106A. When the user authentication is succeeded, the management program 202 notifies the terminal 20A of the success of the user authentication. Upon reception of the position information indicating a position of the terminal 20A which is transmitted from the terminal 20A in response to the notification, the management program 202 reads out area information corresponding to the position of the terminal 20A from the area database file 106B based on the received position information. The management program 202 registers reception date/time information indicating a reception date/time of the area information and position information in the user information corresponding to the terminal 20A.

When receiving the position information and user ID from a terminal for which the area information is registered in the user information, the management program 202 updates the reception date/time and area information in the user information. If a difference between the reception date/time in the information and current date/time exceeds a set time, the server deletes the area information and address information from the user information.

Upon reception of the image data file and user ID from the terminal 20A, the management program 202 stores the image data file in the storage device 106. The management program 202 registers the address information indicating the storage location of the image data file in the storage device 106 in the user information corresponding to the terminal 20A.

The management program 202 reads out the area information from the user information corresponding to the terminal 20A. The management program 202 searches for user information including the read out area information. The management program 202 transmits a user name included in the found user information to the terminal 20A.

When receiving a request of sharing a photo of another user from the terminal 20A, the management program 202 reads out the address information from the user information corresponding to the user name of another user. The management program 202 transmits the image data file to the terminal 20A based on the address information.

Moreover, when receiving a request of performing photographing using a camera of another terminal (e.g., terminal 20B), the management program 202 requests the terminal 20B to perform photographing. The terminal 20B performs photographing in response to the request made by another terminal. The terminal 20B transmits an image data file obtained by photographing to the server 10. Upon reception of the image data file, the management program 202 transmits the image data file to the terminal 20A.

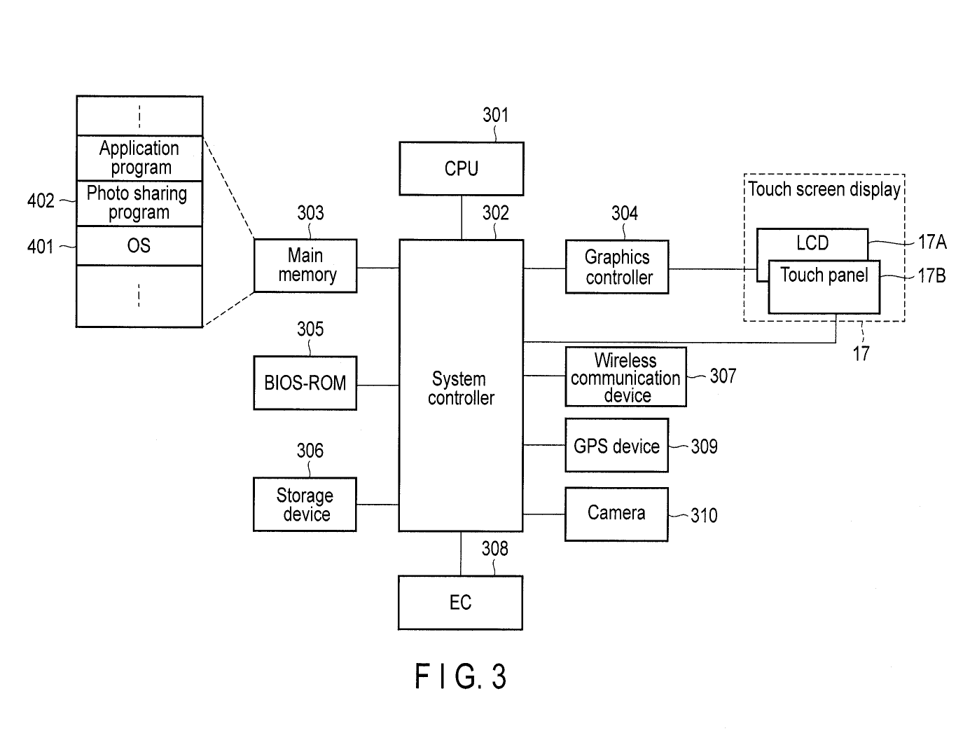

FIG. 3 is a view illustrating a system configuration of the terminal 20 in the embodiment.

As illustrated in FIG. 3, the terminal 20 includes a CPU 301, a system controller 302, a main memory 303, a graphics controller 304, a BIOS-ROM 305, a storage device 306, a wireless communication device 307, an embedded controller (EC) 308, a GPS device 309, a camera 310, and the like.

The CPU 301 is a processor that controls operations of various modules in the terminal 20. The CPU 301 executes various programs loaded from the storage device 306 into the main memory 303. The program executed by the CPU 301 includes various application programs such as an operating system (OS) 401 and a photo sharing program 402.

The CPU 301 executes the photo sharing program 402 to thereby realize various functions involving sharing of a photo photographed by another terminal.

Moreover, the CPU 301 executes a BIOS (Basic Input/Output System) stored in the BIOS-ROM 305. The BIOS is a program for hardware control.

The system controller 302 is a device that connects a local bus of the CPU 301 and various components. The system controller 302 incorporates therein a memory controller for access control of the main memory 303. Moreover, the system controller 302 has a function of executing communication with the graphics controller 304 through a serial bus or the like.

The graphics controller 304 is a display controller that controls an LCD 17A used as a display monitor of the server 10. A display signal generated by the graphics controller 304 is transmitted to the LCD 17A. The LCD 17A displays a screen image based on the display signal. On the LCD 17A, a touch panel 17B is disposed as a position detection device. The touch panel 17B is an electrostatic capacitance-type pointing device for input operation on a screen of the LCD 17A. A contact position of a finger on the screen, movement of the contact position, and the like are detected by the touch panel 17B.

The wireless communication device 307 is a device configured to execute wireless communication such as wireless LAN or 3G mobile communication.

The EC 308 is a one-chip microcomputer that includes an embedded controller for power management. The EC 308 has a function of powering on or off the terminal 20 in response to user's power button operation.

The GPS (Global Positioning System) device 309 is a device that detects a position of the terminal 20.

Upon start-up, the photo sharing program 402 transmits the user ID and password to the server 10. Upon reception of a notification of success of user identification based on the user ID and password from the server 10, the photo sharing program 402 acquires position information indicating the position of the terminal 20 from the GPS device 309. The photo sharing program 402 periodically transmits the position information to the server 10.

After photographing is performed by the camera 310, the photo sharing program 402 transmits the image data file to the server 10. Upon reception of names of users existing in the same area, the photo sharing program 402 displays a list of the user names on the LCD 17A. Based on execution of operation for photo sharing, the photo sharing program 402 requests photo sharing. Upon reception of the image data file which is transmitted from the server in response to the request, the photo sharing program 402 displays an image based on the image data file on the LCD 17A.

The photo sharing may be performed as follows. When one user name whose photo is to be shared is selected from the user name list, the photo sharing program 402 requests sharing of a photo corresponding to the selected user name. Upon reception of an image data file photographed by a terminal corresponding to the user name which is transmitted from the server in response to the request, the photo sharing program 402 displays an image based on the image data file on the LCD 17A.

Moreover, when one user name is selected from the user name list to perform photographing using a terminal corresponding to the selected user name, the photo sharing program 402 requests photographing using the terminal corresponding to the selected user name. Upon reception of an image data file photographed by the terminal corresponding to the user name which is transmitted from the server in response to the request, the photo sharing program 402 displays an image based on the image data file on the LCD 17A.

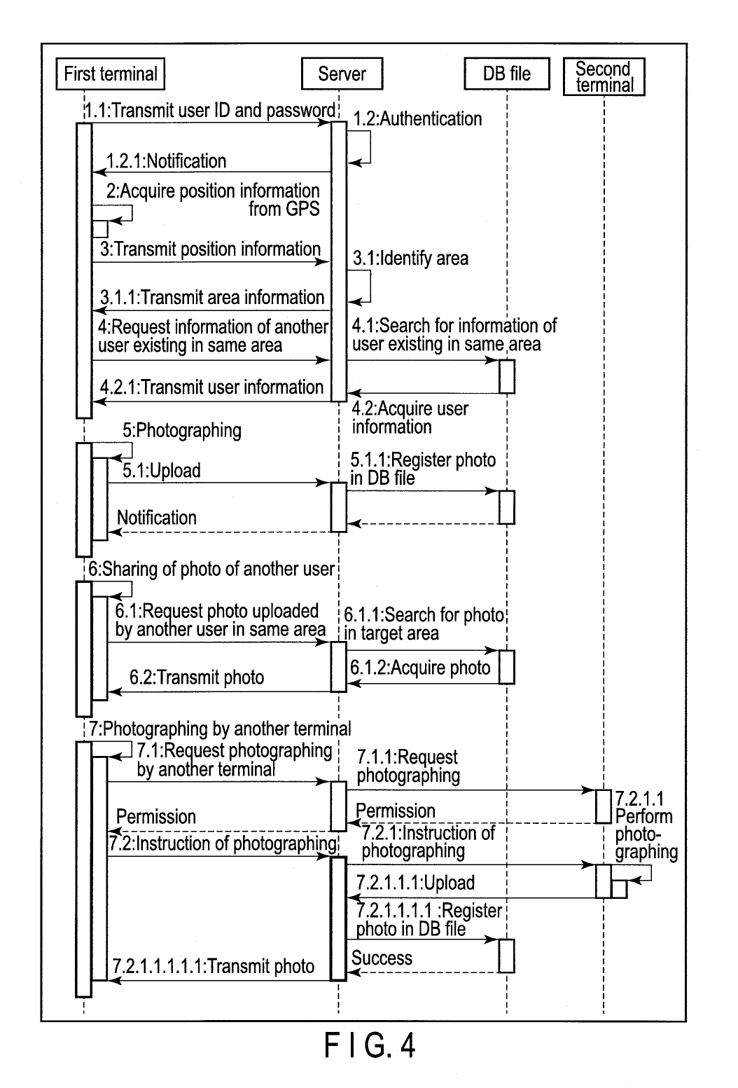

The following describes a procedure for the photo sharing with reference to FIG. 4.

The photo sharing program 402 of a first terminal (terminal 20A) transmits the user ID and password to the server 10 (1.1). The management program 202 of the server 10 performs authentication using the user ID and password stored in the management database file 106A and received user ID and password (1.2). When the authentication is succeeded, the management program 202 notifies the terminal 20A of the success of the authentication (1.2.1).

In response to the notification, the photo sharing program 402 of the terminal 20A acquires the position information from the GPS device 309 (2). The photo sharing program 402 of the terminal 20A transmits the position information to the server 10 (3). The management program 202 of the server 10 identifies the area of the terminal 20A using the area database file 106B and received position information (3.1). The management program 202 of the server 10 transmits the area information to the terminal 20A (3.1.1).

The photo sharing program 402 of the terminal 20A requests information of other users existing in the same area from the server (4). The management program 202 of the server 10 searches the management database file 106A for user names corresponding to terminals located in the same area as that in which the terminal 20A is located (4.1). Then, the management program 202 of the server 10 acquires, from the management database file 106A, the user names corresponding to the terminals located in the same area as that in which the terminal 20A is located (4.2). The management program 202 of the server 10 transmits, to the terminal 20A, the user names corresponding to the terminals located in the same area as that in which the terminal 20A is located (4.2.1).

When the photographing is performed by the terminal 20A (5), the photo sharing program 402 of the terminal 20A transmits the image data file and user ID to the server 10 (5.1). The management program 202 of the server 10 stores the image data file in the storage device 106. The management program 202 of the server 10 registers the address information indicating the storage location of the image data file in the user information corresponding to the user ID registered in the management database file 106A (5.1.1). When the registration is succeeded, the management program 202 of the server 10 notifies the terminal 20A of the success of the registration.

When a user performs an operation for sharing a photo uploaded by another user in the same area (6), the photo sharing program 402 of the terminal 20A requests the photo uploaded by another user in the same area from the server 10 (6.1). The management program 202 of the server 10 searches the management database file 106A for the user information including the area information corresponding to the terminal 20A (6.1.1). Then, the management program 202 of the server 10 acquires the address information indicating the storage location of the image database file, which is included in the user information found in the management database file 106A. Based on the address information, the management program 202 acquires, from the storage device 106, the image data file uploaded by another user in the same area as that in which the user of the terminal 20A exists (6.1.2). The management program 202 of the server 10 transmits the image data file to the terminal 20A based on the acquired user information (6.2).

When a user performs an operation for photographing using a second terminal (terminal 20B) in the same area (7), the photo sharing program 402 of the terminal 20A requests the server 10 to perform photographing using the terminal 20B (7.1). The management program 202 of the server 10 requests the terminal 20B to perform photographing (7.1.1). When the terminal 20B permits the photographing, the management program 202 of the server 10 notifies the terminal 20A of permission of the photographing.

After notification of the permission, the photo sharing program 402 of the terminal 20A instructs the server 10 to perform photographing using the terminal 20B (7.2). The management program 202 of the server 10 instructs the terminal 20B to perform photographing (7.2.1). According to the instruction, the terminal 20B performs photographing (7.2.1.1). The terminal 20B transmits image data file obtained by the photographing to the server 10 (7.2.1.1.1). The management program 202 of the server 10 stores the image data file in the storage device 106. The management program 202 of the server 10 registers the address information indicating the storage location of the image data file in the user information corresponding to the user ID registered in the management database file 106A (7.2.1.1.1.1). When the registration is succeeded, the management program 202 of the server 10 transmits the image data file to the terminal 20A (7.2.1.1.1.1.1).

Although the image data files transmitted from terminals located in the same area are managed in the above embodiment, text files transmitted from terminals located in the same area may be managed, or both the image data files and text files transmitted from terminals in the same area may be managed.

According to the electronic apparatus of the embodiment, terminals located in the same area are managed based on the position information indicating the positions of the terminals, thereby allowing management of the terminals.

Various processing of the embodiment for management of the terminals in the same area can be realized by a computer program, so that by simply installing the computer program in a common computer through a computer-readable storage medium storing therein the computer program and executing it, the same effects as those obtained in the present embodiment can be easily realized.

Various processing of the embodiment for data sharing among the terminals in the same area can be realized by a computer program, so that by simply installing the computer program in a common computer through a computer-readable storage medium storing therein the computer program and executing it, the same effects as those obtained in the present embodiment can be easily realized.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a communication module configured to perform communication with a plurality of terminals and to receive, from the terminals, position information indicating positions of respective terminals and identification information of the respective terminals; and
a manager configured to manage, based on the position information of the respective terminals, one or more identification information transmitted from one or more terminals located in the same area.

2. The apparatus of claim 1, wherein
when the communication module receives data from a first terminal included in the plurality of terminals, the manager is configured to manages data transmitted from the first terminal and data transmitted from one or more terminals located in the same area as that in which the first terminal is located.

3. The apparatus of claim 1, wherein
when the first terminal in the plurality of terminals requests transmission thereto of data transmitted from a second terminal located in the same area as that in which the first terminal is located, the manager is configured to transmit, to the first terminal, the data transmitted from the second terminal by using the communication module.

4. The apparatus of claim 3, wherein the data comprises one of an image data file and a text file.

5. A system comprising a plurality of terminals and an electronic apparatus,
the terminals each comprising:
a measurement module configured to measure a position;
a first communication module configured to perform communication with the electronic apparatus, and
a transmitter module configured to transmit position information indicating the position and identification information to the apparatus using the first communication module,
the electronic apparatus comprising:
a second communication module configured to perform communication with the terminals and receives the position information indicating the position and identification information from the terminals; and
a manager module configured to manage, based on the position information of the respective terminals, one or more identification information transmitted from one or more terminals located in the same area.

6. A management method comprising:
transmitting position information indicating a position and identification information from a plurality of terminals to an electronic apparatus; and
managing, by the apparatus, one or more identification information transmitted from one or more terminals located in the same area based on the position information transmitted from the respective terminals.
